(19) United States
(12) Patent Application Publication
(10) Pub. No.: US 2003/0082973 A1
(43) Pub. Date: May 1, 2003

(54) Adhesive tape or sheet of non-woven fluorine-containing resin fabric

(75) Inventors: Katsutoshi Yamamoto, Osaka (JP); Jun Asano, Osaka (JP); Seigo Yamamoto, Osaka (JP); Tomohisa Konishi, Osaka (JP); Shinichi Chaen, Osaka (JP)

Correspondence Address: SUGHRUE MION, PLLC, 2100 PENNSYLVANIA AVENUE, N.W., WASHINGTON, DC, 20037, US

(73) Assignee: DAIKIN INDUSTRIES, LTD.

(21) Appl. No.: 10/282,092

(22) Filed: Oct. 29, 2002

(30) Foreign Application Priority Data
Oct. 30, 2001 (JP) 2001-332243

(51) Int. Cl. B32B 27/04

(52) U.S. Cl. 442/149

(57) ABSTRACT

There is provided an adhesive tape or sheet which makes it possible to maintain an adhesion strength for a long period of time, is excellent in sliding property and can be used cut to a desired size and shape in case of need. The adhesive tape or sheet or a cut tape thereof comprises a non-woven fabric of a fluorine-containing resin fiber having, partly or wholly on its one surface, an adhesive layer or a pressure sensitive adhesive layer through or not through a substrate layer.

### BACKGROUND OF THE INVENTION

The present invention relates to an adhesive tape or sheet of a non-woven fabric which is made of a fluorine-containing resin fiber and has an adhesive layer or a pressure sensitive adhesive layer on its one surface.

Fluorine-containing resins are excellent in chemical resistance, heat resistance, surface lubricity, releasing property and electric insulating property and are used in various fields making the best use of such properties.

For example, for applications making the use of lubricity (sliding property) thereof, a fluorine-containing resin sheet or film is adhered to surfaces of parts or products to enhance lubricity between the parts or between the products.

JP7-292332A discloses, as a tape used at a heat-generating part of a device for heat sealing, a pressure sensitive adhesive tape comprising a substrate which is a fluorine-containing resin film or a heat resistant fabric material impregnated with a fluorine-containing resin, in which a pressure sensitive adhesive is applied partly to one surface of the substrate. Also it is disclosed that when the adhesive tape is adhered to a surface of a heating element, an effect of not causing wrinkling on the plastic film to be heat-sealed is exhibited.

However since the fluorine-containing resin film itself is small in its surface energy and inferior in tackiness (adhesive property) with other material, it is difficult to hold a pressure sensitive adhesive on the fluorine-containing resin film for a long period of time and usually it is necessary that the resin film is subjected to surface treatment such as defluorination treatment. Also in case of the heat resistant fabric material impregnated with a fluorine-containing resin only on its one surface, there is a problem that during the use thereof, the fluorine-containing resin is easily removed due to an external stress, etc.

An object of the present invention is to provide a tape or sheet which makes the best use of a characteristic of the fluorine-containing resin, namely excellent lubricity (sliding property) and can be used adhered for a long period of time.

### SUMMARY OF THE INVENTION

Namely the present invention relates to an adhesive tape or sheet of a non-woven fabric which is made of a fluorine-containing resin fiber and has an adhesive layer or a pressure sensitive adhesive layer partly or wholly on its one surface.

Also the present invention relates to an adhesive tape or sheet of a non-woven fabric which is made of a fluorine-containing resin fiber and has an adhesive layer or a pressure sensitive adhesive layer partly or wholly on its one surface through a substrate layer.

Those adhesive tapes and sheets may be cut to a desired form.

Preferred fluorine-containing resin is a polytetrafluoroethylene (PTFE), particularly a semi-sintered PTFE.

A preferred substrate is a fibrous substrate for reinforcement.

### BRIEF EXPLANATION OF THE DRAWINGS

FIG. 1 is a diagrammatic cross-sectional view of the first embodiment of the present invention.

FIG. 2 is a diagrammatic cross-sectional view of the second embodiment of the present invention.

FIG. 3 is a diagrammatic plan view of the cut tape of the present invention.

FIG. 4 is a diagrammatic cross-sectional view of the cut tape of the present invention.

FIG. 5 is a diagrammatic cross-sectional view of one embodiment of use of the adhesive tape of the present invention.

### DETAILED DESCRIPTION

A structure of the adhesive tape or sheet of the present invention is explained below according to the drawings (mentioned hereinafter is the explanation in case of the tape, but the explanation can be applied to the sheet, too). FIG. 1 represents the first embodiment of the present invention. The adhesive tape 1 has a laminated structure comprising a non-woven fluorine-containing resin fabric 2 and a pressure sensitive adhesive layer 3. The pressure sensitive adhesive layer 3 may be an adhesive layer.

As mentioned above, since the fluorine-containing resin itself is inferior in affinity for other material, it is preferable in the present invention that the tape has such a structure that the pressure sensitive adhesive layer 3 is invading the inside of one side of the non-woven fluorine-containing resin fabric 2.

FIG. 2 is the second embodiment of the present invention. A structure thereof is such that a substrate layer 4 is provided between the non-woven fluorine-containing resin fabric 2 and the pressure sensitive adhesive layer 3. For a substrate of the layer 4, materials described infra can be used. When the substrate is fibrous (woven fabric or non-woven fabric), it is preferable that the non-woven fluorine-containing resin fabric 2 is mechanically entangled with the substrate. The pressure sensitive adhesive layer 3 is formed on a free surface of the substrate layer 4. As shown in FIG. 2, it is preferable, from the viewpoint of strength and flexibility, that the non-woven fluorine-containing resin fabric 2 is mechanically laminated with the substrate layer 4 so that the respective surfaces are partly entangled with each other. Also the both may be adhered to each other with an adhesive. If a strength of the non-woven fluorine-containing resin fabric is small, it is desirable to use a fibrous substrate for reinforcement as a substrate.

In the embodiments of FIGS. 1 and 2, a releasing paper (tape) made of known material may be adhered to a free surface of the pressure sensitive adhesive layer. The releasing paper is not shown in those figures.

The adhesive tape of the present invention is stored in the form of a wound roll and is cut to a necessary size when used.

In case of the form of sheet, it may be cut to an optional shape to a shape of a part where it is adhered.

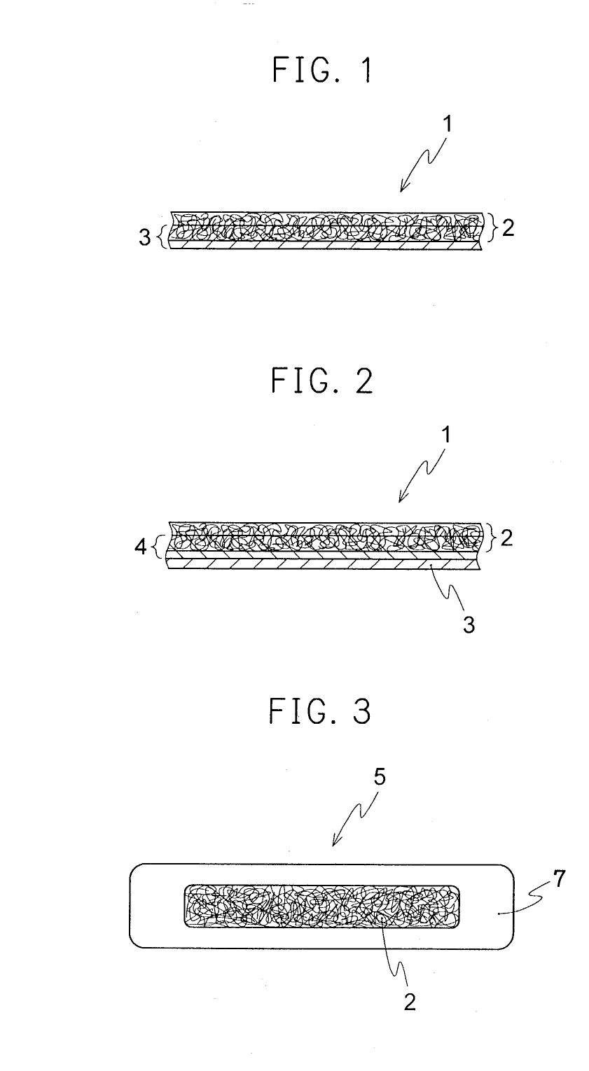

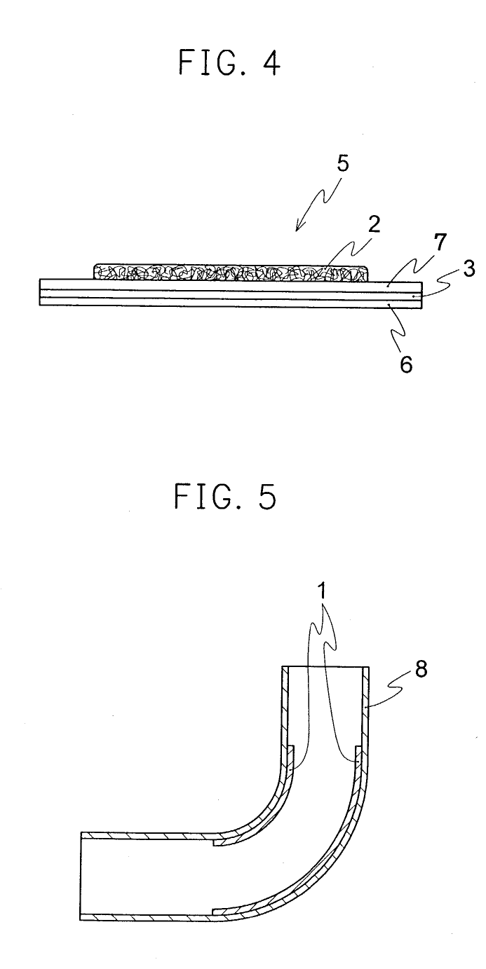

Next, a so-called cut tape shown in FIGS. 3 and 4 is explained below. In FIGS. 3 and 4, numeral 5 represents the cut tape. The non-woven fluorine-containing resin fabric 2 is laminated (adhered) with the substrate 7, and on the other side of the substrate 7 are provided the pressure sensitive adhesive layer 3 and a releasing paper 6.

When various sizes of cut tapes 5 are prepared, they can be adhered to desired parts immediately in case of need.

Then the materials of each layer of the tape of the present invention are explained below.

As the fluorine-containing resin to be used for the non-woven fluorine-containing resin fabric imparting lubricity, preferred are, for example, polytetrafluoroethylene (PTFE), tetrafluoroethylene/perfluoro(alkyl vinyl ether) copolymer (PFA), tetrafluoroethylene/hexafluoropropylene copolymer (FEP), ethylene/tetrafluoroethylene copolymer (ETFE), polychlorotrifluoroethylene (PCTFE) and the like which have a static friction coefficient of not more than 0.1. Further particularly preferred is PTFE which has the smallest static friction coefficient. Among PTFE, most preferred is a semi-sintered PTFE when the non-woven fabric is subjected to various surface treatments, for example, when the surface treatment is carried out by heating and compressing for making the surface smooth and preventing fluffing. Those resins can be used alone or in a mixture of two or more thereof. Also when melt-processable fluorine-containing resins such as PFA, FEP, ETFE and PCTFE are used alone or in a mixture thereof, a strength of the non-woven fluorine-containing resin fabric can be increased.

The non-woven fabric can be obtained by forming a fibrillated fluorine-containing resin to a non-woven fabric through usual method. For the fibrillation of the fluorine-containing resin, there are mechanical fibrillation methods such as a tearing method, splitting method and slitting method, chemical spinning methods such as an emulsion spinning method and melt-spinning method, and the like. Though the fibrillation method is not limited particularly, the mechanical fibrillation methods which can form branches and loops on the fluorine-containing resin fibers are preferred from the point that a non-woven fabric having a high strength can be obtained.

The mechanical fibrillation methods and fibers obtained thereby which are described, for example, in GB1531720B, WO94/23098, WO96/00807, WO96/10662, WO96/10668, WO97/26135, etc. can be used.

Also a non-fluorine-containing fiber may be mixed together with the fluorine-containing resin fiber in a range not lowering lubricity. Examples of the preferable non-fluorine-containing fiber are, for instance, natural fibers (wool, cotton, silk, etc.), general purpose chemical fibers (polyethylene, polypropylene, acrylic resin, rayon, polyamide, polyester, etc.), heat-resistant chemical fibers (meta-linked aramid fiber, para-linked aramid fiber, polyimide, polyamideimide, polyphenylene sulfide, phenol resin, etc.), inorganic fibers (carbon, glass) and the like. The mixing of non-fluorine-containing fiber provides such effects that an amount of relatively expensive fluorine-containing resin can be decreased, an adhesive strength with an adhesive or a pressure sensitive adhesive can be increased, an abrasion resistance is increased and feeling of touch is changed. When the non-woven fabric is used on parts where heat resistance is required, a heat-resistant resin such as meta-linked aramid fiber, para-linked aramid fiber, polyimide, polyamideimide, polyphenylene sulfide or phenol resin can be mixed suitably. Also heat-melting resins such as polyethylene, polypropylene and polyamide are suitable for strengthening the bonding between the fluorine-containing resin fibers by melting thereof.

Though an average diameter of the fibers is not limited particularly, it is desirable for non-woven fabric application that the average diameter of the fiber is from about 5 μm to about 20 μm and the average fiber length is from about 5 mm to about 50 mm.

For making the non-woven fabric, there can be used the same methods as conventional methods such as a method using a carding machine and a paper making method. From the point that there can be obtained a non-woven fabric having increased strength while lowering its unit weight, preferred is a water jet method.

From economical point of view, a smaller unit weight of the non-woven fluorine-containing resin fabric is preferred for its use to obtain sliding property (lubricity). The unit weight is suitably from 10 to 250 g/m², more suitably from 20 to 200 g/m², particularly suitably from 25 to 150 g/m². When the unit weight is too small, a damage due to abrasion is quickened, and when the unit weight is too large, intermingling of fibers by water jetting is insufficient and a desired strength is difficult to obtain.

For the pressure sensitive adhesive layer, known pressure sensitive adhesives can be used. For example, there are synthetic rubber adhesives such as an acrylic rubber, natural rubber, urethane rubber and butyl rubber, silicone rubber adhesive and the like. Also an adhesive layer may be employed instead of the pressure sensitive adhesive layer. For the adhesive layer, known adhesives, for example, epoxy, un-saturated polyester and ethylene/vinyl acetate adhesives and in addition, hot-melt adhesives such as polyester and polyamide can be used.

The adhesive layer or the pressure sensitive adhesive layer is formed so that a part of an adhesive or a pressure sensitive adhesive invades the inside of the non-woven fluorine-containing resin fabric to strengthen the bonding with the fabric. For forming the layer, usual coating methods such as spraying method, roll coating method and dipping method can be employed.

The pressure sensitive adhesive layer (or the adhesive layer) may be formed wholly or partly on one surface of the non-woven fabric. When the layer is formed partly, it may be formed in a dot-like form, in a linear form or in a lattice form. In case where air permeability is imparted to the fabric, it is preferable that the pressure sensitive adhesive layer is formed partly.

The substrate used on the tape of the second embodiment of the present invention is provided on one side of the non-woven fluorine-containing resin fabric for supporting of the fabric, mainly for increasing a strength of the fabric. Material and form of the substrate are not limited particularly. For example, there are fibrous materials such as non-woven fabric, woven fabric and knitted fabric made of organic and inorganic materials. It is desirable that the material of the substrate is selected in consideration of its affinity for the pressure sensitive adhesive layer to be formed on the opposite side of the substrate.

From the viewpoint of increasing mechanical strength and maintaining flexibility, it is preferable that the lamination of the fibrous substrate with the non-woven fabric is carried out, for example by placing a web of the fluorine-containing resin fiber on the substrate and physically intermingling the both through mechanical intermingling method such as water jet needling, needle punching or the like.

Also in order to enhance smoothness of the surface of the fabric or to prevent fluffing of the surface, a free surface of the non-woven fluorine-containing resin fabric may be subjected to smoothening treatment. Non-limited examples of the smoothening treatment are smoothening methods of pressing a heating roller and plate on the surface of the fabric.

The adhesive tape (or sheet) of the present invention is used for applications making effective use mainly of surface lubricity of the non-woven fluorine-containing resin fabric. Mentioned below are applications of the fabric and embodiments of use thereof, but the present invention is not limited to them.

Inner Surface of Piping:

As shown in FIG. 5, when the tape 1 is adhered on the inner surface of a bending part such as an elbow of the pipe 8 in which an electric wire or a cable is passed through, the wire or the cable (not illustrated) can be inserted or removed easily.

Inner Surface of Heel of Shoes:

When the tape is adhered to the heels of the shoes, a shoe sore is prevented and it becomes easy to wear the shoes even without a shoehorn. The tape or cut tape is suitable for this application. Also the same effect can be obtained when the tape is adhered directly to the heels of a person.

Bottoms of Furniture and Fixtures and Bottoms of Legs Thereof:

There arise no damage on a floor and it becomes easy to carry furniture and fixtures. The cut tape is used or the tape is used cut to a desired size.

Surfaces of Desk Goods:

The tape is adhered to the surfaces (bottom surfaces) of a personal computer, printer, telephone, facsimile machine, etc. which are relatively heavy or is adhered to the surface of a desk to move them easily. Either of the tape and sheet may be used.

Grips of Cooking Apparatuses and Sewing Goods:

The tape is wound on the grips of a pot, a frying pan, scissors, etc. For those applications, characteristics of the fluorine-containing resin such as heat resistance, stain-proofing property, removability of stain, etc. in addition to sliding property can be exhibited.

Also there are other applications. For example, in case of the form of tape, the tape is wound on fingers in fishing and sewing. With respect to heating elements for heat-sealing which are described in JP7-292332A, the tape is wound on the surfaces thereof for sliding and releasing purposes.

The tape in the form of sheet (including the case of cutting to a desired size) is adhered to portions of jeans which are rubbing against skins (knee, inside of a thigh, etc.), is adhered to a stretcher for an emergency medial use to enable a patient to be moved easily or is adhered to bedsores of a patient to enable him to move easily.

Further in case of a cut tape, in addition to the above-mentioned applications, there are other uses. For example, when a cut cotton (gauze) similar to conventional cut tape for protecting a wound is adhered partly to the pressure sensitive adhesive layer of the present invention so that the cut cotton (gauze) touches a skin and the outer surface of the tape is the non-woven fluorine-containing resin fabric, even after the adhesion, there is no sliding of the cut tape and the wound can be protected. For example, the tape is effectively used for shoe sores in cases of mountaineering, skiing, running, etc. and also as a finger tape for fishing.

The adhesive tape or sheet of the present invention makes it possible to maintain an adhesion strength for a long period of time, is excellent in sliding property and can be used cut to a desired size and shape in case of need.

What is claimed is:

1. An adhesive tape or sheet comprising a non-woven fabric which is made of a fluorine-containing resin fiber and has an adhesive layer or a pressure sensitive adhesive layer partly or wholly on its one surface.

2. An adhesive tape or sheet comprising a non-woven fabric which is made of a fluorine-containing resin fiber and has an adhesive layer or a pressure sensitive adhesive layer partly or wholly on its one surface through a substrate layer.

3. The adhesive tape or sheet obtained by cutting the adhesive tape or sheet of claim 1 to a given form.

4. The adhesive tape or sheet obtained by cutting the adhesive tape or sheet of claim 2 to a given form.

5. The adhesive tape or sheet of claim 1, wherein the fluorine-containing resin is a polytetrafluoroethylene.

6. The adhesive tape or sheet of claim 5, wherein the polytetrafluoroethylene is a semi-sintered polytetrafluoroethylene.

7. The adhesive tape or sheet of claim 2, wherein the fluorine-containing resin is polytetrafluoroethylene.

8. The adhesive tape or sheet of claim 7, wherein the polytetrafluoroethylene is a semi-sintered polytetrafluoroethylene.

9. The adhesive tape or sheet of claim 3, wherein the fluorine-containing resin is a polytetrafluoroethylene.

10. The adhesive tape or sheet of claim 9, wherein the polytetrafluoroethylene is a semi-sintered polytetrafluoroethylene.

11. The adhesive tape or sheet of claim 4, wherein the fluorine-containing resin is polytetrafluoroethylene.

12. The adhesive tape or sheet of claim 11, wherein the polytetrafluoroethylene is a semi-sintered polytetrafluoroethylene.

13. The adhesive tape or sheet of claim 2, wherein the substrate layer is a fibrous substrate for reinforcement of the non-woven fabric.

14. The adhesive tape or sheet of claim 4, wherein the substrate layer is a fibrous substrate for reinforcement of the non-woven fabric.

15. The adhesive tape or sheet of claim 7, wherein the substrate layer is a fibrous substrate for reinforcement of the non-woven fabric.

16. The adhesive tape or sheet of claim 8, wherein the substrate layer is a fibrous substrate for reinforcement of the non-woven fabric.

17. The adhesive tape or sheet of claim 11, wherein the substrate layer is a fibrous substrate for reinforcement of the non-woven fabric.

18. The adhesive tape or sheet of claim 12, wherein the substrate layer is a fibrous substrate for reinforcement of the non-woven fabric.
